(19) United States
(12) Patent Application Publication
(10) Pub. No.: US 2021/0190245 A1
(43) Pub. Date: Jun. 24, 2021

(54) ULTRA-COMPACT TUBE OR PIPE COUPLING FOR VACUUM, LIQUID OR GAS

(71) Applicant: JEFFERSON SCIENCE ASSOCIATES, LLC, Newport News, VA (US)

(72) Inventor: DAVID KASHY, Newport News, VA (US)

(21) Appl. No.: 16/724,238

(22) Filed: Dec. 21, 2019

(51) Int. Cl. F16L 23/036; F16L 23/00

(52) U.S. Cl. CPC F16L 23/036; F16L 23/003

(57) ABSTRACT

A pipe coupling system including a pair of tubular flange halves and a plurality of clamp segments. A seal resides in a groove on the flange face. The tube mating ends are secured to the pipe or tubing. The flange halves are then drawn together and the seal is compressed. The clamp segments are placed around the periphery of the joined flanges. The pipe coupling system advantageously separates the functions of squeezing the seal from tightening the flanges, minimizes the total space required for achieving a seal, is easily disassembled and reassembled without causing significant process downtime, minimizes the radial space needed beyond the outer diameter of the pipe, and effectively seals against leakage of vacuum, liquid, or gas.

The United States Government may have certain rights to this invention under Management and Operating Contract No. DE-AC05-06OR23177 from the Department of Energy.

### FIELD OF THE INVENTION

The present invention relates to pipe or tube couplings, and more specifically the creation of a secure pipe or tube coupling in an area that has limited radial space.

### BACKGROUND

In terms of space, the most efficient conventional coupling for connecting two tubes or pipes is butt welding. Other conventional pipe coupling methods include soldering or brazed socket couplings. Epoxy or other adhesive can also be used in a socket type application. All of these are substantially permanent coupling methods that require significant effort to remove and remake the connections.

However, in many cases a piping system must be assembled without welding or brazing, such as in those systems in which the coupling must be broken down at intervals during operation of the system. In this situation, a permanent coupling method such as welding would not permit a routine breaking down and reassembly of the coupling.

Additionally, conventional flanged coupling systems for pipes or tubes, require significant radial space to allow for bolts or clamps. Thus flanged piping systems are unusable in many systems in which there is limited radial space for bolts or clamps around the pipe, such as beam pipes for physics experiments, which require thin wall beam pipes. Each beam pipe must hide within a narrow cone so as not to impact the experimental results by blocking the path of particles of interest or impeding particles that need to pass by unaffected.

Accordingly, there is a need for a tube or pipe coupling that can be easily disassembled and remade without causing significant process downtime, requires minimal radial space beyond the outer diameter of the pipe, and can effectively seal against leaking of vacuum, liquid, or gas. Such a tube or pipe coupling would be useful for allowing for maximum internal passageway for beam pipes that must pass through hardware having narrow apertures and close clearance to the apertures. Such a tube or pipe coupling would also be beneficial in other applications that require minimal radial space beyond the outer diameter of the pipe, including cryogenic lines and RF waveguides

### OBJECTS AND ADVANTAGES OF THE INVENTION

The object of the present invention is to provide a pipe coupling system that separates the functions of compressing the seal material and holding the flange system secure.

A second object is to provide a pipe coupling system that is compact, requiring little space beyond the outer diameter of the pipe.

A further object is to provide a pipe coupling system that can be easily disassembled and reassembled.

Another object is to provide a pipe coupling system that effectively seals against leaking of vacuum, liquid, or gas.

These and other objects and advantages of the present invention will be understood by reading the following description along with reference to the drawings.

### SUMMARY OF THE INVENTION

The present invention is a pipe coupling system including a pair of tubular flange halves and a plurality of clamp segments. A seal resides in a groove on the flange face. The tube mating ends are secured to the pipe or tubing. The flange halves are then drawn together and the seal is compressed. The clamp segments are placed around the periphery of the joined flanges. The pipe coupling system advantageously separates the functions of squeezing the seal from tightening the flanges, minimizes the total space required for achieving a seal, is easily disassembled and reassembled without causing significant process downtime, minimizes the radial space needed beyond the outer diameter of the pipe, and effectively seals against leakage of vacuum, liquid, or gas.

### BRIEF DESCRIPTION OF THE SEVERAL VIEWS OF THE DRAWING(S)

Reference is made herein to the accompanying drawings, which are not necessarily drawn to scale, and wherein:

FIG. 1 is a sectional view of an assembled pipe coupling system according to the invention.

FIG. 2 is a sectional view of the pipe coupling system with a temporary seal compression tool.

FIG. 3 is a side elevation view of two flange halves used in the pipe coupling system of the present invention.

FIG. 4 is an end view of a four segment clamp for securing the pipe coupler to a pipe or tube.

FIG. 5 is a sectional view of a clamp segment taken along line 5-5 of FIG. 4.

FIG. 6 is an end view of the flanged end of the male flange half of a pipe coupler according to the invention.

FIG. 7 is an end view of the flanged end of the female flange half of a pipe coupler according to the invention.

### DETAILED DESCRIPTION

Conventional flange systems typically use clamps or bolts to both squeeze a seal and to secure two flanges for pressure and mechanical loads. In the current invention, the functions of compressing the seal material and holding the flange system secure have been separated. The pipe coupling system of the invention advantageously requires little additional radial space beyond the tube outside diameter (OD).

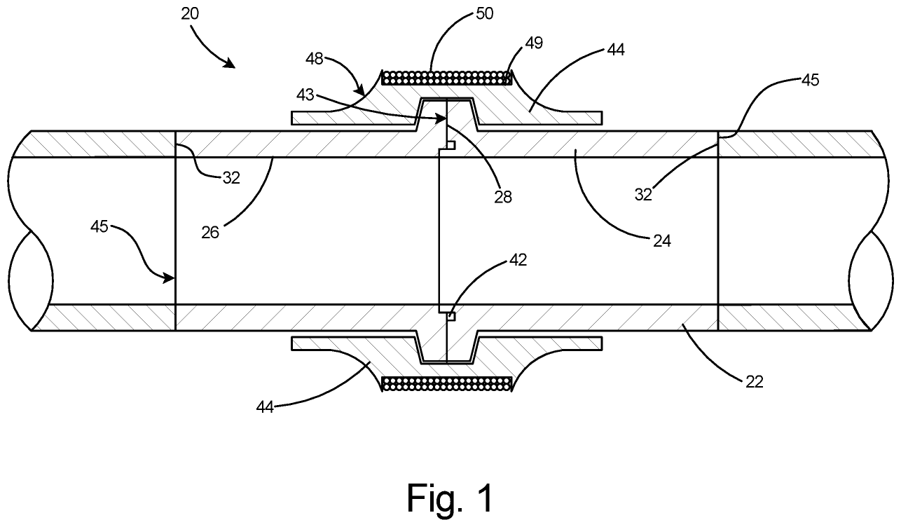

With reference to FIG. 1, a pipe coupling system 20 according to the invention includes two pipe couplers 22, each coupler 22 having two tubular flange halves, including a male flange half 24 and a female flange half 26. Each flange half includes a flanged end 28 and a tube mating end 32.

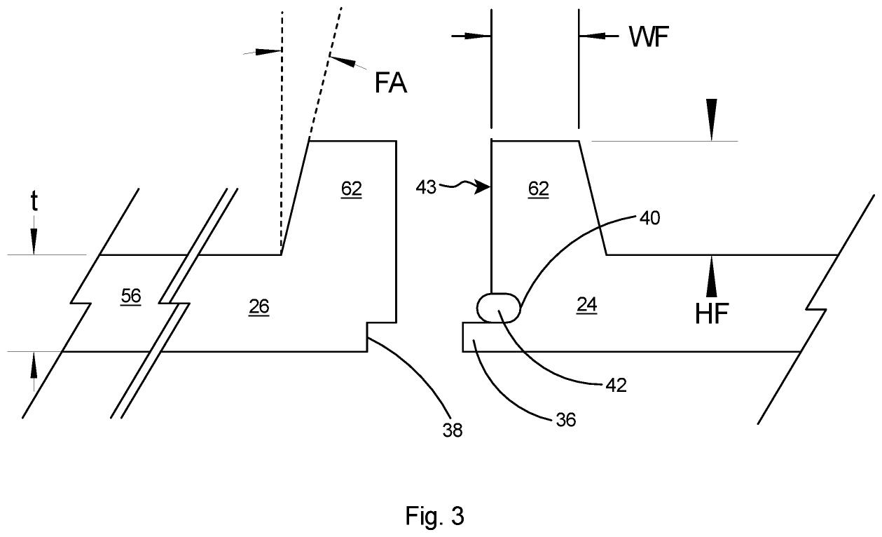

Referring to FIG. 3, the male flange half 24 preferably includes a leg 36 thereon and the female flange half 26 includes a notch 38 to receive the leg of the male flange half when the two are drawn together. Male flange half 24 includes a seal groove 40 for insertion of a seal 42 therein.

Referring to FIG. 1, the flanged ends 28 each include a flange face 43. Two or more clamp segments 44 are installed around the mated flanges 24 and 26. Each clamp segment 44 includes a load surface 48 and an outer groove 49. The clamp segments 44 are secured with an elongated fastening device 50. The elongated fastening device 50 is preferably wire, string, or similar elongated material that is preferably wrapped multiple times around the outer groove 49 of the clamp segments 44 similar to a bobbin of thread and knotted off.

To operate the invention, the tube mating ends 32 of each flange are cleaned and attached to the adjacent tube ends 45 via welding or brazing, or the tube ends 45 can be machined to create integral flange halves on the tube ends.

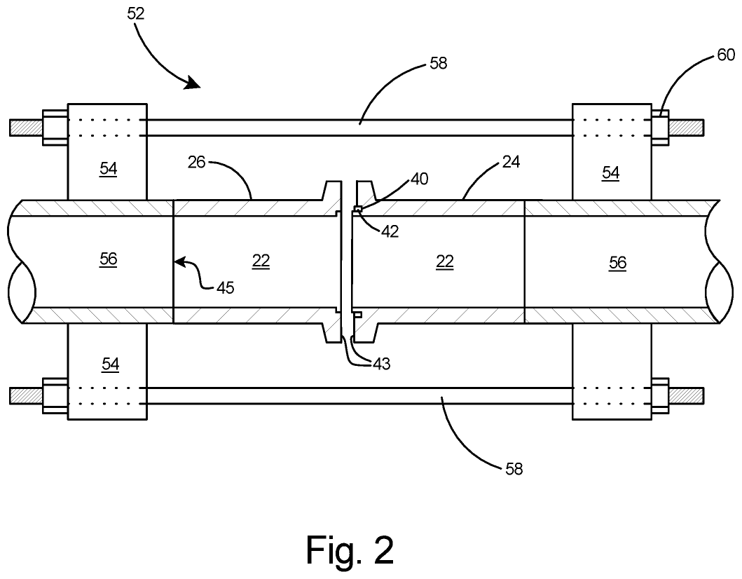

Referring to FIG. 2, a sealing tool 52 for compression of the seal 42 is temporarily attached to each tube assembly and the pipe couplers 22 and tube ends 45 tightly together, between mating flange faces 43. Seals can be O-rings or of any shape to fill the seal grooves 40. The seals can be constructed of rubber, plastic, or a deformable metal such as indium. For an indium seal the indium is squeezed into the seal groove 40. In the embodiment shown in FIG. 2, the sealing tool 52 includes two split clamps 54 affixed to the tubes 56, a seal compression rod 58, and a nut 60 tightened to each end of the seal compression rod 58.

With reference to FIG. 3, the flange halves 24 and 26 include a flange angle FA. The flange angle FA is preferably less than 15 degrees in order to maintain the desired compression of the seal 42 by the clamp segments 44. After initial compression by the sealing tool, the clamp segments 44 require only a few thousandths of an inch of radial draw to clamp the assembly.

Flange portion 62 includes an optimal width WF that is application dependent and can be calculated from the thickness t of the tubes 56 and the height HF of the flange portions 62. The height of the flanges 62 is preferably set to approximately the thickness. The width WF of the flange portion 62 is preferably 2 to 10 t.

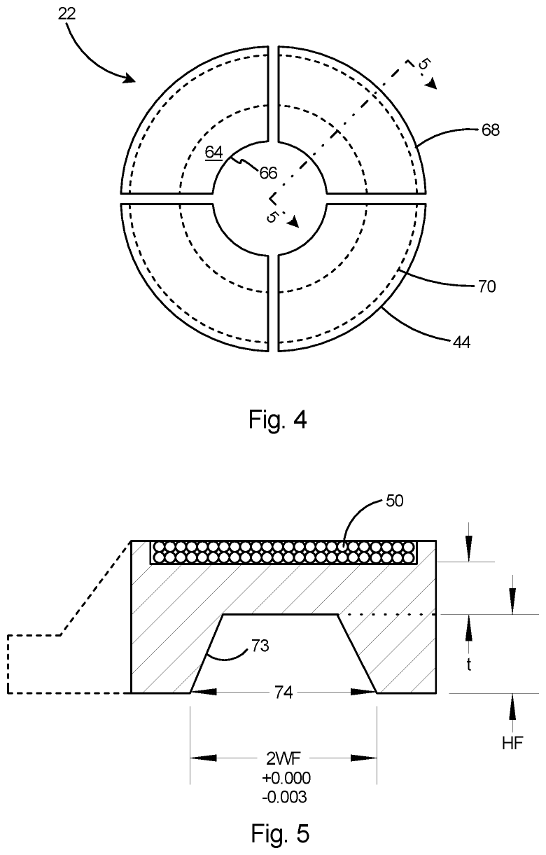

With reference to FIG. 4, there is shown an exemplary pipe coupling 22 having four clamp segments 44 each including an arcuate inner periphery 66 at the innermost extent of the flange gap 64, an arcuate outer periphery 68, and an arcuate surface 70 on the outer groove 49.

Referring to FIG. 5, each clamp segment 44 preferably includes a mouth 74 with a tolerance of +0.000, −0.003 inch. The tolerance insures that the clamp segment 44 will fit over the mated flanges of the pipe coupler 22 and, when tightened by the elongated fastening device 50, will further compress the flange halves toward one another, lock the faces of the flange halves together, and further compress the seal. Flange gap 64 includes sidewalls 73 that are substantially the same angle as the flange angle 61 (see FIG. 3) of the flanges.

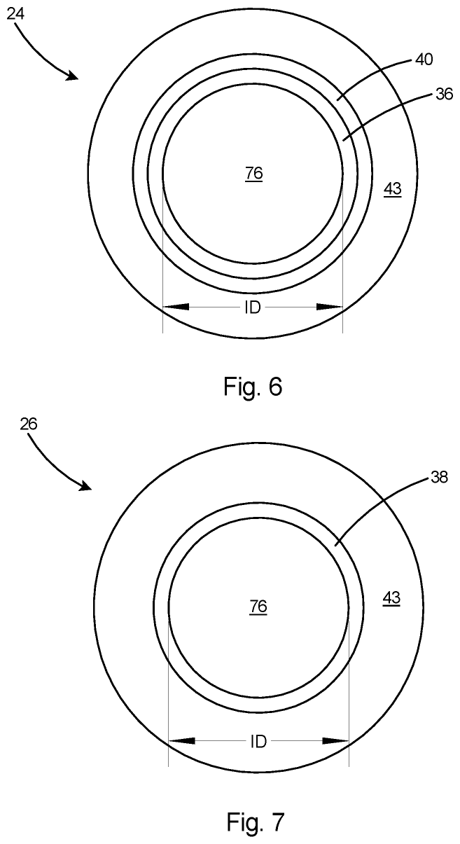

With reference to FIG. 6, the male flange half 24 includes the leg 36, the seal groove 40, and the flange face 43. As shown in FIG. 7, female flange half 26 includes the notch 38 to receive the leg of the male flange half when the two are drawn together. Male and female flange halves will each include an opening 76 having an inner diameter ID substantially matching the inner diameter of the tube it is affixed to. Flange half 24 will include a seal 42 (see FIG. 3) within the seal groove 40 when the two flanged ends are drawn together.

The pipe coupling system 20 according to the invention advantageously separates the functions of squeezing the seal from the tightening the flanges, minimizes the total space required for achieving a seal without requiring welding or brazing, is easily disassembled and reassembled without causing significant process downtime, minimizes the radial space needed beyond the outer diameter of the pipe, and effectively seals against leakage of vacuum, liquid, or gas. Flanges on either end can be same or different materials, and they can be hard plastics, glass or metal.

Seals can be constructed of rubber, metal O-rings, C-rings, or soft metal like indium. The groove must match the selected seal profile. Depending on the pressure rating and loads on the piping system, the increase in outside diameter (OD) of the system can be as small as or smaller than 3× the wall thickness of the tube or pipes involved. If the system can allow for reduced flow area the outside diameter of the clamped area can be equal to the OD of the attached tubes or pipes. The flange geometry is chosen to require low hoop load restraint requirements on the securing system. This is accomplished by choosing the slope of the flange to be nearly perpendicular to the axis of the pipe/tube, most preferably no greater than 15 degrees from perpendicular to the axis of the pipe/tube.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A pipe coupling system for joining two tubes, comprising:
a pipe coupler including two tubular flange halves;
the flange halves including a central axis;
said flange halves including a flanged end having a flange and a tube mating end; and
a sealing tool for drawing said flange halves together along said central axis.

2. The pipe coupling system of claim 1 comprising two or more clamp segments arranged peripherally around the circumference of said pipe coupler.

3. The pipe coupling system of claim 1 comprising:
alignment means on said flange halves; and
said alignment means including a leg on a first of said flange halves and a a notch on a second of said flange halves to receive the leg of the opposing flange half when the two are drawn together to form joined flanges.

4. The pipe coupling system of claim 3 comprising:
a groove on one of said flange ends of said flange halves; and
a seal in said groove.

5. The pipe coupling system of claim 4 comprising:
an outer groove on said clamp segment; and
a gap on said clamp segment.

6. The pipe coupling system of claim 5 comprising:
said joined flanges including a width;
said gap of said clamp segment including a clearance; and
said clearance of said clamp segment is twice the width of the joined flanges.

7. The pipe coupling system of claim 6 comprising:
said tubes having a tube thickness;
said flanges include a flange width; and
the flange width is set to 2 to 10 times the tube thickness.

8. The pipe coupling system of claim 7 comprising:
said flanges include a flange height; and
the flange height is set to the thickness of the tubes.

9. The pipe coupling system of claim 8 comprising an elongated fastening device to secure said clamp segments to said pipe coupler and tubes.

10. The pipe coupling system of claim 9 wherein said elongated fastening device is selected from the group consisting of wire and string.

11. The pipe coupling system of claim 10 comprising:
a flange angle on said flanges of said flange halves; and
said flange angle is less than 15 degrees with respect to the central axis of the flange halves.

12. The pipe coupling system of claim 5 comprising:
sidewalls on said gap of said clamp segments; and
said sidewalls at an angle equal to the flange angle of the flange halves.

13. A method of coupling two tubes having tube ends together, comprising:
two tubular flange halves including a flanged end with a flange having a flange face with a seal, a tube mating end, and a central axis;
two or more clamp segments including a gap with sidewalls and an outer groove;
a sealing tool;
an elongated fastener having two ends;
securing the tube mating ends of the flange halves to the tube ends; and
drawing the flange halves and connected tube ends together to form joined flanges;
placing the two or more clamp segments around the periphery of the joined flanges; and
securing the clamp segments to the joined flanges by wrapping the elongated fastener around the clamp segments and securing the two ends of the fastener together.

14. The method of claim 13 comprising a groove in said flange face and a seal in said groove.

15. The method of claim 14 comprising:
said flanges include a flange height; and
the flange height is equal to the thickness of the tubes.

16. The method of claim 15 comprising:
a flange angle on said flanges of said flange halves; and
said flange angle is less than 15 degrees with respect to the central axis of the flange halves.

17. The method of claim 16 comprising:
said sidewalls at an angle to the central axis; and
the angle of the sidewalls of the clamp segments is equal to the flange angle of the flange halves.

18. The method of claim 17 comprising:
said joined flanges including a width;
said gap of said clamp segment including a clearance; and
said clearance of said clamp segment is twice the width of the joined flanges.

19. The method of claim 18 comprising:
said tubes having a tube thickness;
said flanges include a flange width; and
the flange width is 2 to 10 times the tube thickness.

20. The method of claim 19 wherein said elongated fastening device is selected from the group consisting of wire and string.
